(19) United States
(12) Patent Application Publication
(10) Pub. No.: US 2017/0302631 A1
(43) Pub. Date: Oct. 19, 2017

(54) METHOD AND SYSTEM FOR ROUTING WITH MINIMUM NAME DISCLOSURE IN A CONTENT CENTRIC NETWORK

(71) Applicant: CISCO TECHNOLOGY, INC., San Jose, CA (US)

(72) Inventors: Christopher A. Wood, San Francisco, CA (US); Glenn C. Scott, Portola Valley, CA (US)

(73) Assignee: CISCO TECHNOLOGY, INC., San Jose, CA (US)

(21) Appl. No.: 15/132,045

(22) Filed: Apr. 18, 2016

(51) Int. Cl. H04L 29/06; H04L 12/745

(52) U.S. Cl. CPC H04L 63/0428; H04L 45/748

(57) ABSTRACT

One embodiment provides a system that facilitates routing with minimum name disclosure in a CCN. During operation, the system adds a first entry to a local forwarding information base for a first name prefix and a corresponding first suffix encryption key indicated in a first advertisement. In response to receiving a first interest with a name that includes the first name prefix, the system performs a lookup in the forwarding information base for the first interest name to obtain the first entry. The system encrypts a suffix of the first interest name based on the first suffix encryption key, wherein the suffix begins from a name component following the first name prefix. The system forwards the first interest to one or more interfaces indicated in the first entry, thereby facilitating routing with minimum name disclosure in a content centric network.

### RELATED APPLICATIONS

The subject matter of this application is related to the subject matter in the following applications:

U.S. patent application Ser. No. 13/847,814 (Attorney Docket No. PARC-20120537-US-NP), entitled “ORDERED-ELEMENT NAMING FOR NAME-BASED PACKET FORWARDING,” by inventor Ignacio Solis, filed 20 Mar. 2013 (hereinafter “U.S. patent application Ser. No. 13/847,814”); and

U.S. patent application Ser. No. 12/338,175 (Attorney Docket No. PARC-20080626-US-NP), entitled “CONTROLLING THE SPREAD OF INTERESTS AND CONTENT IN A CONTENT CENTRIC NETWORK,” by inventors Van L. Jacobson and Diana K. Smetters, filed 18 Dec. 2008 (hereinafter “U.S. patent application Ser. No. 12/338,175”); the disclosures of which are herein incorporated by reference in their entirety.

### BACKGROUND

### Field

This disclosure is generally related to distribution of digital content. More specifically, this disclosure is related to a method and system for facilitating routing with minimal name disclosure by allowing producers to advertise name prefixes and forwarders to modify local forwarding information bases with corresponding suffix encryption keys.

### Related Art

The proliferation of the Internet and e-commerce continues to create a vast amount of digital content. Content centric network (CCN) architectures have been designed to facilitate accessing and processing such digital content. A CCN includes entities, or nodes, such as network clients, forwarders (e.g., routers), and content producers, which communicate with each other by sending interest packets for various content items and receiving content object packets in return. CCN interests and content objects are identified by their unique names, which are typically hierarchically structured variable length identifiers (HSVLI). An HSVLI can include contiguous name components ordered from a most general level to a most specific level.

A CCN data packet (such as an interest or content object) is routed based on its name. Some name components may be used by an intermediate node to route a CCN interest, while other name components may be used by a content producer to satisfy a request based on private user information or application-specific data. In the latter case, the meaningfulness of the name components may reveal information regarding the requested content and may result in a breach of user privacy or security. A consumer may encrypt the interest name, but a sufficient number of name components must remain unencrypted for routing purposes. This “minimum routable prefix” is the maximal name length (e.g., maximum number of name components) needed to route an interest to a content producer who can satisfy the content request.

While a CCN brings many desired features to a network, some issues remain unsolved in providing a system that uses the routing protocol, via forwarders of various network devices, to perform routing with minimum name disclosure.

### SUMMARY

One embodiment provides a system that facilitates routing with minimum name disclosure in a CCN. During operation, the system adds a first entry to a local forwarding information base for a first name prefix and a corresponding first suffix encryption key indicated in a first advertisement, wherein a name is a hierarchically structured variable length identifier that includes contiguous name components ordered from a most general level to a most specific level, and wherein a name prefix indicates one or more contiguous name components beginning from the most general level. In response to receiving a first interest with a name that includes the first name prefix, the system performs a lookup in the forwarding information base for the first interest name to obtain the first entry. The system encrypts a suffix of the first interest name based on the first suffix encryption key, wherein the suffix begins from a name component following the first name prefix. The system forwards the first interest to one or more interfaces indicated in the first entry, thereby facilitating routing with minimum name disclosure in a content centric network.

In some embodiments, the first advertisement is generated by a content producing device that can satisfy a request for an interest with a name that includes the first name prefix and can decrypt, based on a private key of the content producing device, a suffix encrypted based on the suffix encryption key.

In some embodiments, the system adds a second entry to the forwarding information base for a second name prefix and a corresponding second suffix encryption key indicated in a second advertisement. The system determines to aggregate the first and second entries into a new entry for an aggregated name prefix. The system generates a public key that is a new suffix encryption key and a corresponding private key that is a new suffix decryption key. The system replaces the first and second entries with the new entry that indicates one or more of: the aggregated name prefix; the new suffix encryption key; the new suffix decryption key; interfaces indicated in the first and second entries; and a list of original name prefixes, suffix encryption keys, and interfaces, wherein the original name prefixes, suffix encryption keys, and interfaces are indicated in the first and second entries.

In some embodiments, the system determines that one or more name components of the first name prefix are the same as one or more name components of the second name prefix.

In some embodiments, the system transmits a new advertisement to a downstream node, wherein the new advertisement indicates the aggregated name prefix and the new suffix encryption key.

In some embodiments, the system receives a second interest with a name that includes the aggregated name prefix and an encrypted suffix. The system performs a lookup in the forwarding information base for the second interest name to obtain a corresponding entry.

In some embodiments, in response to determining that the corresponding entry is the new entry, the system performs the following operations: decrypts the encrypted suffix based on the new suffix decryption key to obtain a decrypted name; performs a lookup in the list based on the decrypted name to obtain an original name prefix, an original suffix encryption key, and original interfaces; encrypts a new suffix of the decrypted name based on the original suffix encryption key to obtain a re-encrypted name, wherein the new suffix begins from a name component following the original name prefix; and forwards the second interest with the re-encrypted name to the original interfaces.

In some embodiments, in response to determining that the corresponding entry indicates a suffix encryption key with a null value, the system forwards the second interest to interfaces indicated in the corresponding entry.

In some embodiments, the system receives an updated advertisement that indicates a third name prefix and a corresponding third suffix encryption key. In response to determining that an entry for the third name prefix exists in the forwarding information base, and in response to determining that the third suffix encryption key is not the same as the suffix encryption key indicated in the existing entry, the system replaces the suffix encryption key with the third suffix encryption key. In response to determining that an entry for the third name prefix does not exist in the forwarding information base, the system performs the following operations: adds a third entry to the forwarding information base for the third name prefix and the corresponding third suffix encryption key; and, in response to determining to aggregate the first and second entries, replaces the first and second entries with the third entry.

In some embodiments, the method is performed by a local forwarder of the system, and the system is a client computing device or an intermediate node or router in a content centric network.

### BRIEF DESCRIPTION OF THE FIGURES

FIG. 1A illustrates an exemplary network which facilitates routing with minimum name disclosure in a content centric network, including a first advertisement, in accordance with an embodiment of the present invention.

FIG. 1B illustrates an exemplary network which facilitates routing with minimum name disclosure in a content centric network, including a data communication corresponding to FIG. 1A, in accordance with an embodiment of the present invention.

FIG. 1C illustrates an exemplary network which facilitates routing with minimum name disclosure in a content centric network, including a second advertisement and route aggregation, in accordance with an embodiment of the present invention.

FIG. 1D illustrates an exemplary network which facilitates routing with minimum name disclosure in a content centric network, including a third advertisement based on route aggregation, in accordance with an embodiment of the present invention.

FIG. 1E illustrates an exemplary network which facilitates routing with minimum name disclosure in a content centric network, including a data communication corresponding to FIGS. 1C and 1D, in accordance with an embodiment of the present invention.

FIG. 2A illustrates an exemplary forwarding information base of a router, corresponding to FIG. 1A, in accordance with an embodiment of the present invention.

FIG. 2B illustrates an exemplary forwarding information base of a router that accounts for route aggregation, corresponding to FIG. 1A, in accordance with an embodiment of the present invention.

FIG. 2C illustrates an exemplary forwarding information base of a router after modification based on route aggregation, corresponding to FIGS. 1C and 1D, in accordance with an embodiment of the present invention.

FIG. 2D illustrates an exemplary forwarding information base of a client computing device, corresponding to FIG. 1A, in accordance with an embodiment of the present invention.

FIG. 2E illustrates an exemplary forwarding information base of a client computing device after modification based on route aggregation, corresponding to FIGS. 1C and 1D, in accordance with an embodiment of the present invention.

FIG. 2F illustrates an alternative exemplary forwarding information base of a client computing device after modification based on route aggregation, corresponding to FIGS. 1C and 1D, in accordance with an embodiment of the present invention.

FIG. 3 illustrates an exemplary system which facilitates routing with minimum name disclosure in a content centric network, in accordance with an embodiment of the present invention.

FIG. 4A presents a flow chart illustrating a method by an intermediate router for facilitating routing with minimum name disclosure in a content centric network, in accordance with an embodiment of the present invention.

FIG. 4B presents a flow chart illustrating a method by an intermediate router for facilitating routing with minimum name disclosure in a content centric network, in accordance with an embodiment of the present invention.

FIG. 4C presents a flow chart illustrating a method by an intermediate router for facilitating routing with minimum name disclosure in a content centric network, in accordance with an embodiment of the present invention.

FIG. 5 presents a flow chart illustrating a method by a client computing device for facilitating routing with minimum name disclosure in a content centric network, in accordance with an embodiment of the present invention.

FIG. 6 presents a flow chart illustrating a method by a content producing device for facilitating routing with minimum name disclosure in a content centric network, in accordance with an embodiment of the present invention.

FIG. 7 illustrates an exemplary computer system that facilitates routing with minimum name disclosure in a content centric network, in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system which facilitates routing with minimum name disclosure based on a routing protocol in which producers advertise name prefixes and forwarders modify their local forwarding information bases. A CCN data packet (e.g., an interest or a content object) is routed based on its name, which can include multiple name components. Some of the name components may be used for routing purposes, while other name components may contain sensitive user information or application-specific data. A consumer may encrypt the interest name, but a sufficient number of name components must remain unencrypted in order for the interest to be routed to a producer that can satisfy the interest or serve the requested content. Embodiments of the present invention allow a publisher to advertise a name prefix and a corresponding public key that can be used to encrypt a suffix of an interest name following the name prefix. The advertised public key is also known as the suffix encryption key. The publisher also generates the corresponding private key, known as the suffix decryption key.

A downstream CCN node or entity (e.g., a client computing device such as a consumer, or an intermediate node such as a router, forwarder, or other forwarding device) that receives the advertisement can update its local FIB to include an entry for the name prefix, the suffix encryption key, and the appropriate outgoing interfaces. Subsequently, the node's local forwarder can receive an interest with a name that is not encrypted. In determining how to forward the interest, the forwarder can perform a longest prefix match search in the FIB. The forwarder can obtain a FIB entry which corresponds to a name prefix of the interest name, and encrypt a suffix of the interest name based on the suffix encryption key, where the suffix includes the name components after the obtained name prefix. The node can subsequently forward the interest with the encrypted suffix based on the outgoing interfaces indicated in the FIB entry. Upon receiving the interest, the publisher can use its private key (e.g., the suffix decryption key) to decrypt the interest name and generate the responsive content. Thus, the forwarders for nodes that are downstream from the publisher can use the information in their respective FIB s to encrypt suffixes of interest names, which results in routing with minimum name disclosure.

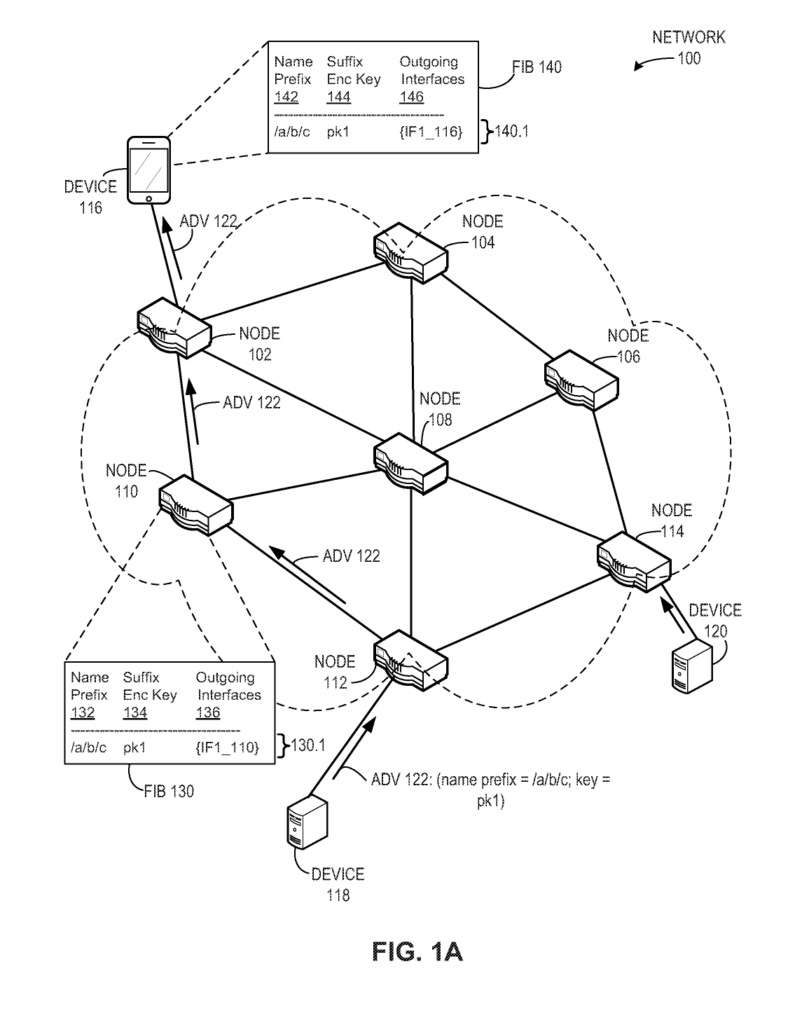

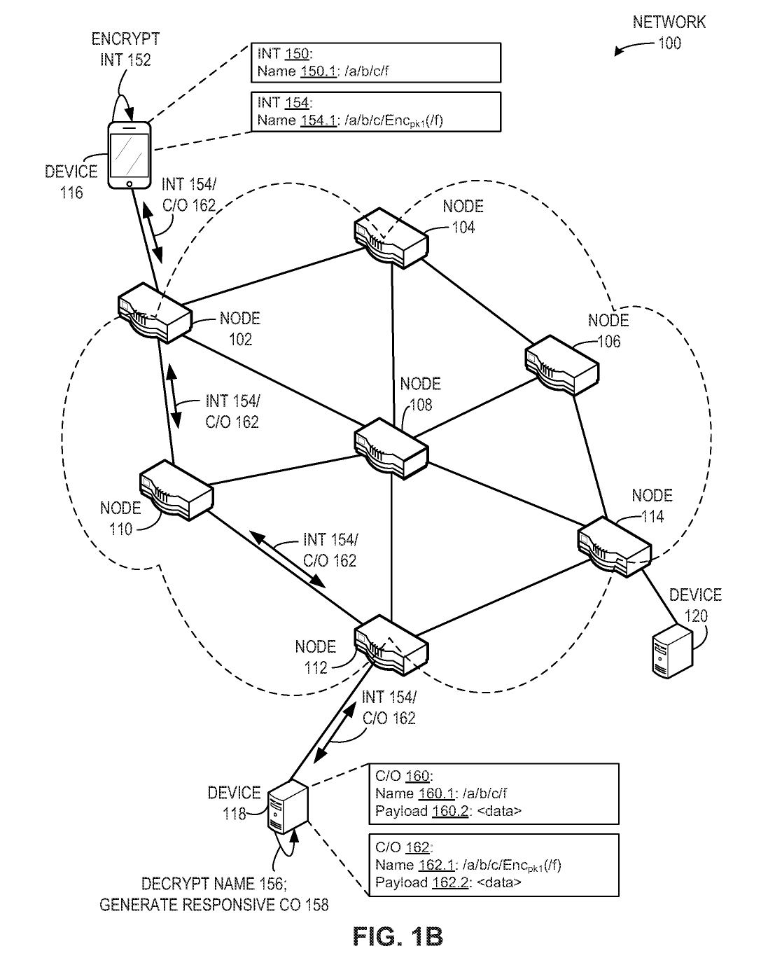

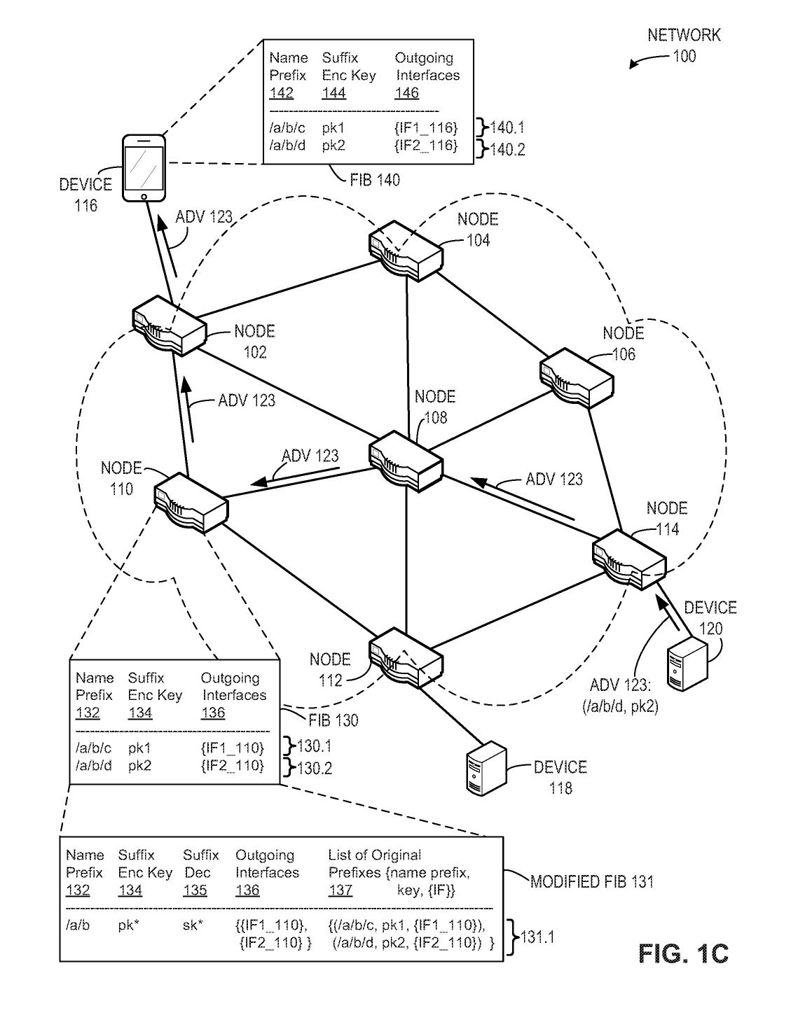

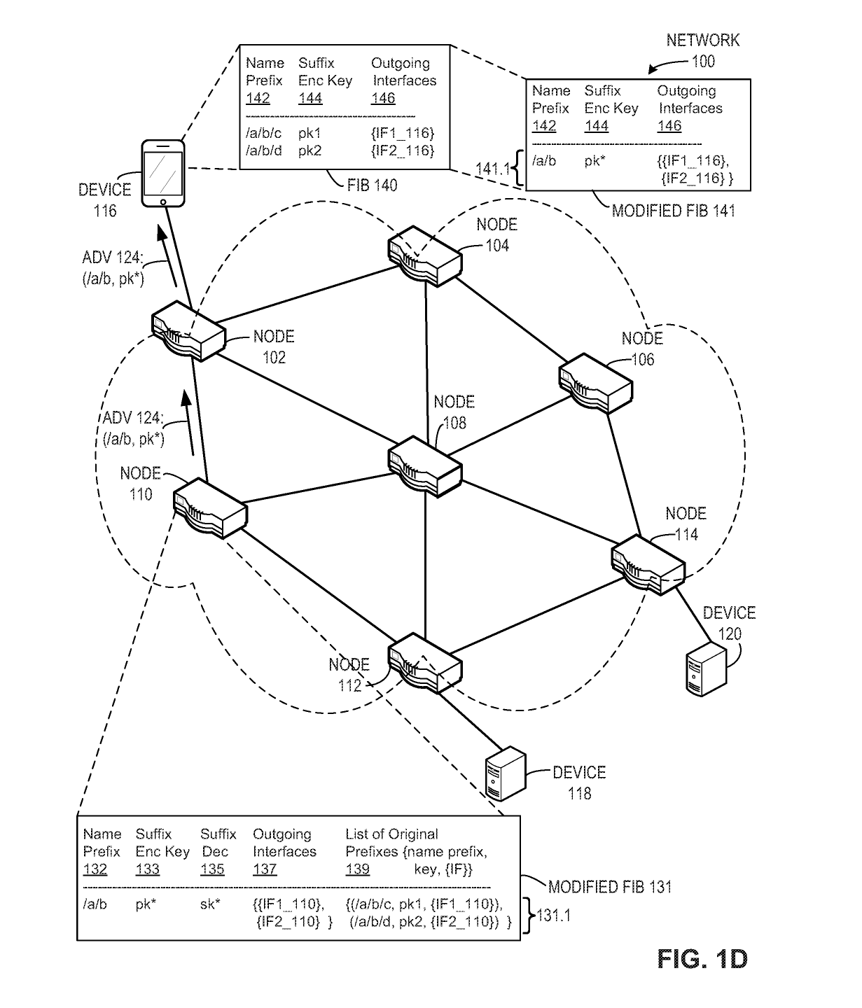

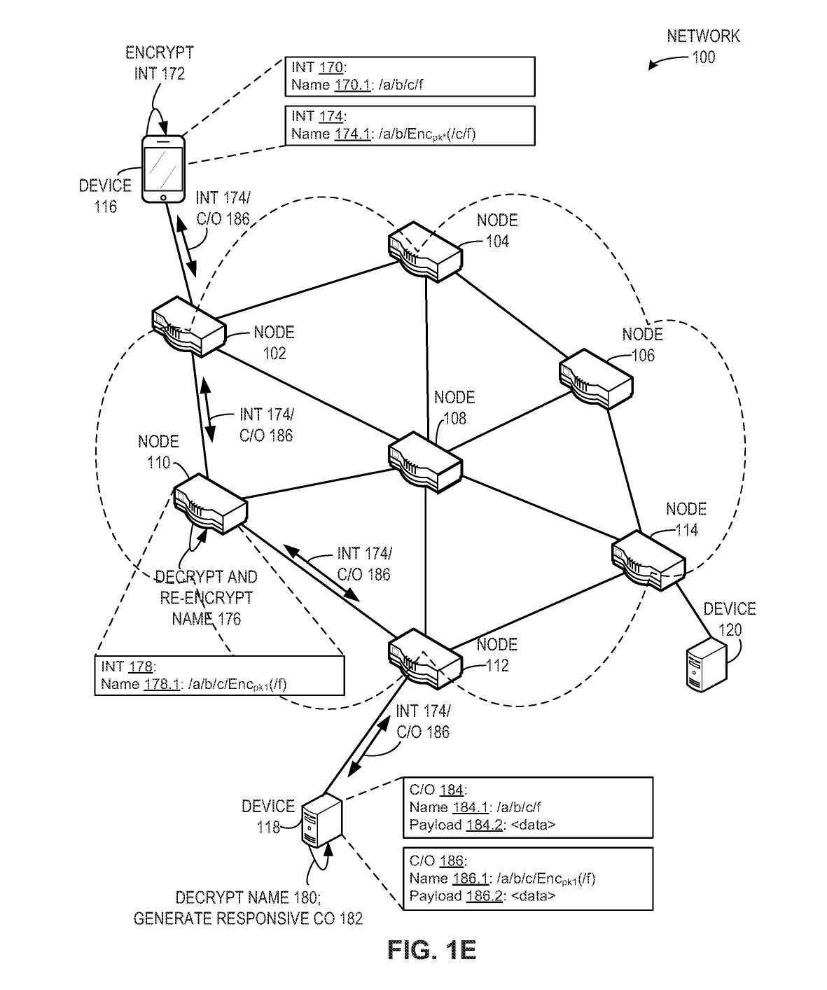

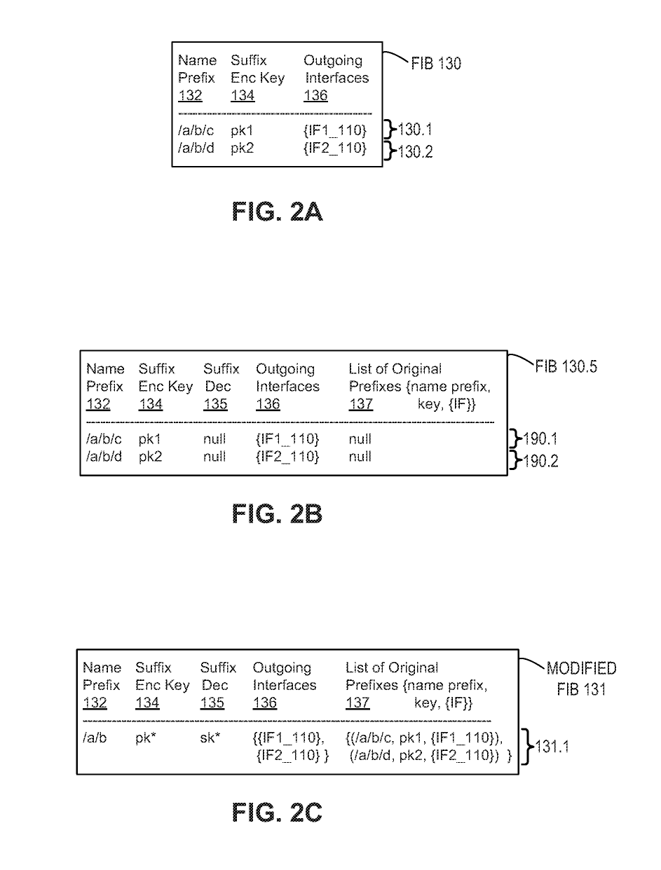

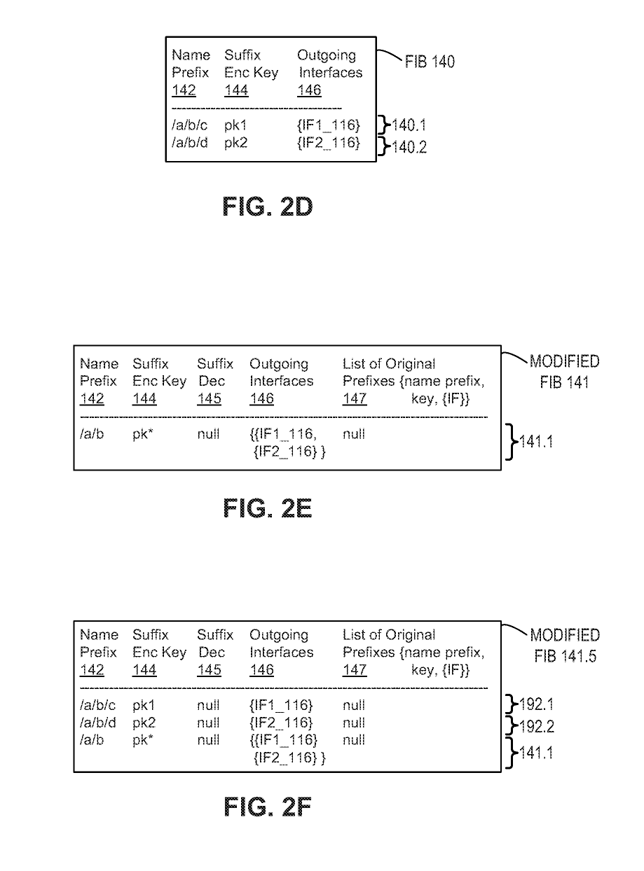

Embodiments of the present invention also allow an intermediate router to perform route aggregation by collapsing multiple entries into one for an aggregated name prefix, generating new suffix encryption and decryption keys, and publishing an updated advertisement for the aggregated name prefix and the new suffix encryption key. A downstream CCN node or entity that receives the updated advertisement can update its own local FIB similarly (by replacing the collapsed entries with a new entry). This facilitates routing with minimum name disclosure, as depicted below in relation to FIGS. 1D and 2E. Alternatively, a downstream CCN node may simply add an entry corresponding to the updated advertisement, and make subsequent forwarding decisions based on policies of the forwarder or the device which the forwarder serves, as depicted below in relation to FIGS. 1D and 2F.

In CCN, each piece of content is individually named, and each piece of data is bound to a unique name that distinguishes the data from any other piece of data, such as other versions of the same data or data from other sources. This unique name allows a network device to request the data by disseminating a request or an interest that indicates the unique name, and can obtain the data independent from the data's storage location, network location, application, and means of transportation. The following terms are used to describe the CCN architecture:

Content Object (or “Content Object”):

A single piece of named data, which is bound to a unique name. Content Objects are “persistent,” which means that a Content Object can move around within a computing device, or across different computing devices, but does not change. If any component of the Content Object changes, the entity that made the change creates a new Content Object that includes the updated content, and binds the new Content Object to a new unique name.

Unique Names:

A name in a CCN is typically location independent and uniquely identifies a Content Object. A data-forwarding device can use the name or name prefix to forward a packet toward a network node that generates or stores the Content Object, regardless of a network address or physical location for the Content Object. In some embodiments, the name may be a hierarchically structured variable-length identifier (HSVLI). The HSVLI can be divided into several hierarchical components, which can be structured in various ways. For example, the individual name components parc, home, ccn, and test.txt can be structured in a left-oriented prefix-major fashion to form the name “/parc/home/ccn/test.txt.” Thus, the name “/parc/home/ccn” can be a “parent” or “prefix” of “/parc/home/ccn/test.txt.” Additional components can be used to distinguish between different versions of the content item, such as a collaborative document. The HSVLI can also include contiguous name components ordered from a most general level to a most specific level.

In some embodiments, the name can include an identifier, such as a hash value that is derived from the Content Object's data (e.g., a checksum value) and/or from elements of the Content Object's name. A description of a hash-based name is described in U.S. patent application Ser. No. 13/847,814, which is herein incorporated by reference. A name can also be a flat label. Hereinafter, “name” is used to refer to any name for a piece of data in a name-data network, such as a hierarchical name or name prefix, a flat name, a fixed-length name, an arbitrary-length name, or a label (e.g., a Multiprotocol Label Switching (MPLS) label).

Interest (or “interest”): A packet that indicates a request for a piece of data, and includes a name (or a name prefix) for the piece of data. A data consumer can disseminate a request or Interest across an information-centric network, which CCN/NDN routers can propagate toward a storage device (e.g., a cache server) or a data producer that can provide the requested data to satisfy the request or Interest.

The methods disclosed herein are not limited to CCN networks and are applicable to other architectures as well. A description of a CCN architecture is described in U.S. patent application Ser. No. 12/338,175, which is herein incorporated by reference.

### Exemplary Network and Communication

FIG. 1A illustrates an exemplary network 100 which facilitates routing with minimum name disclosure in a content centric network, including a first advertisement, in accordance with an embodiment of the present invention. A network 100 can include a consumer or content requesting device 116, producers or content producing devices 118 and 120, and a router or other forwarding device at nodes 102, 104, 106, 108, 110, 112, and 114. A node can be a computer system, an end-point representing users, and/or a device that can generate interests or originate content. A node can also be an edge router (e.g., CCN nodes 102, 104, 112, and 114) or a core router (e.g., intermediate CCN routers 106, 108, and 110). Network 100 can be a content centric network.

During operation, producer 118 can publish an advertisement 122 for a name prefix of “/a/b/c” with a suffix encryption key of “pk1.” The advertisement indicates that the name prefix is the minimum routable prefix that a downstream node can use to ensure that an interest with a name that includes the name prefix will reach producer 118. The suffix encryption key is a public key generated by producer 118, who also generates a corresponding private key (e.g., the suffix decryption key). The advertisement also indicates that a downstream node can encrypt, for an interest name that includes the name prefix, a suffix of the interest name based on the suffix encryption key, where the suffix includes the name components following the name prefix.

Upon receiving advertisement 122, a downstream node (e.g., node 110) can update a local FIB 130. An entry in FIB 130 can include a name prefix 132, a suffix encryption key 134, and outgoing interfaces 136. For example, an entry 130.1 can include a name prefix of “/a/b/c,” a suffix encryption key of “pk1,” and outgoing interfaces “{IF1_110}.” Similarly, upon receiving advertisement 122, device 116 can updates its local FIB 140 with an entry 140.1 that includes a name prefix of “/a/b/c,” a suffix encryption key of “pk1,” and outgoing interfaces “{IF1_116}.”

FIG. 1B illustrates exemplary network 100 which facilitates routing with minimum name disclosure in a content centric network, including a data communication corresponding to FIG. 1A, in accordance with an embodiment of the present invention. During operation, client device 116 can generate an interest 150 with a name 150.1 of “/a/b/c/f.” A forwarder or other forwarding component associated with a transport stack of device 116 can determine that a corresponding entry in FIB 140 for a name prefix (e.g., “/a/b/c”) included in interest name 150.1 includes a suffix encryption key. Thus, the forwarder can encrypt a suffix of name 150.1 with the suffix encryption key of “pk1” (function 152) and forward interest 154 with a name 154.1 of “/a/b/c/Encₚₖ₁(/f).” In FIG. 1B, interests 150 and 154 are depicted as separate interests for purposes of illustration. Device 116 can generate a single interest based on function 152.

Interest 154 can travel through network 100 via nodes 102, 110, and 112, before reaching producer 118. Producer 118 can serve content or satisfy requests for content with the prefix of “/a/b/c.” Producer 118, in possession of the corresponding suffix decryption key, can decrypt the encrypted portion of name 154.1 of interest 154 (function 156), and generate a content object 160 with a name 160.1 of “/a/b/c/f” and a payload 160.2 of “<data>” (function 158). Producer 118 can replace name 160.1 in content object 160 with the original partially encrypted name (e.g., name 154.1 of “/a/b/c/Encₚₖ₁(/f)”), and transmit content object 162 to client device 116 on a reverse path (e.g., via nodes 112, 110, and 102).

FIG. 1C illustrates exemplary network 100 which facilitates routing with minimum name disclosure in a content centric network, including a second advertisement and route aggregation, in accordance with an embodiment of the present invention. After the communications depicted in FIGS. 1A and 1B, producer 120 can publish an advertisement 123 for a name prefix of “/a/b/d” with a suffix encryption key of “pk2.” The suffix encryption key is a public key generated by producer 120, who also generates a corresponding private key (e.g., the suffix decryption key). The advertisement also indicates that a downstream node can encrypt, for an interest name that includes the name prefix, a suffix of the interest name based on the suffix encryption key, where the suffix includes the name components following the name prefix.

Upon receiving advertisement 123, a downstream node (e.g., node 110) can update its FIB 130, with an entry 130.2 that includes a name prefix of “/a/b/d,” a suffix encryption key of “pk2,” and outgoing interfaces “{IF2_110}.” Subsequently, node 110 can determine to aggregate routes in FIB 130 by identifying or determining that one or more name components of a first name prefix are the same as one or more name components of a second name prefix. For example, the name prefixes for entries 130.1 and 130.2 each include the common, shared name prefix of “/a/b” (“aggregated name prefix”). Node 110 can generate a public key that is a new suffix encryption key (“pk*”) and a private key that is a new suffix decryption key (“sk*”). Node 110 can replace (e.g., collapse or aggregate) entries 130.1 and 130.2 with a new entry 131.1 of a modified FIB 131. New entry 131.1 can indicate the following: the new aggregated name prefix, “/a/b”; the new suffix encryption key of “pk*”; a suffix decryption key 135 with a value of “sk*”; outgoing interfaces that include both “{IF1_110}” and “{IF2_110}”; and a list of original prefixes 137. List 137 for entry 131.1 can include the original name prefix, suffix encryption key, and outgoing interfaces for each collapsed or aggregated FIB entry.

In addition, upon receiving advertisement 123, client device 116 can updates its local FIB 140 with an entry 140.2 that includes a name prefix of “/a/b/d,” a suffix encryption key of “pk2,” and outgoing interfaces “{IF2_116}.” In some embodiments, device 116 can also perform a route aggregation on the entries in its FIB 140 (not shown).

FIG. 1D illustrates exemplary network 100 which facilitates routing with minimum name disclosure in a content centric network, including a third advertisement based on route aggregation, in accordance with an embodiment of the present invention. After creating entry 131.1 in modified FIB 131, node 110 can publish an advertisement 124 for the aggregated name prefix of “/a/b” with a corresponding suffix encryption key of “pk*.” Advertisement 124 can be transmitted to and received by nodes that are downstream from router 110. Thus, client device 116 can receive advertisement 124 and update its FIB 140 (shown in modified FIB 141) with an entry 141.1 that includes a name prefix of “/a/b,” a suffix encryption key of “pk*,” and outgoing interfaces “{IF1_116}” and “{IF2_116}.” Client device 116 can either aggregate entries 140.1 and 140.2 into new entry 141.1, or can add new entry 141.1 to FIB 140. Client device 116 can make this determination based on a policy of the device or an associated forwarder.

FIG. 1E illustrates exemplary network 100 which facilitates routing with minimum name disclosure in a content centric network, including a data communication corresponding to FIGS. 1C and 1D, in accordance with an embodiment of the present invention. During operation, client device 116 can generate an interest 170 with a name 170.1 of “/a/b/Encₚₖ*(/c/f).” A forwarder or other forwarding component associated with a transport stack of device 116 can determine that a corresponding entry in FIB 140 (or modified FIB 141) for a name prefix (e.g., “/a/b”) included in interest name 170.1 includes a suffix encryption key. Thus, the forwarder can encrypt a suffix of name 170.1 with the suffix encryption key of “pk*” (function 172) and forward interest 174 with a name 174.1 of “/a/b/Encₚₖ*(/c/f).” In FIG. 1E, interests 170 and 174 are depicted as separate interests for purposes of illustration. Device 116 can generate a single interest based on function 172.

Interest 174 can travel through network 100 and reach node 110. Node 110 can perform a lookup in its FIB 141 (to obtain entry 141.1), identify the suffix encryption key “pk*,” and decrypt and re-encrypt the name (function 176) by using the corresponding suffix decryption key “sk*” to obtain a decrypted name. Node 110 can then determine, from the list of original prefixes indicated in entry 141.1, to decrypt the name again based on the corresponding original name prefix (e.g., “/a/b/c”), using the indicated original suffix encryption key (e.g., “pk1”). Thus, node 110 can transmit an interest 178 with a name 178.1 of “/a/b/c/Encₚₖ₁(/f).”

Interest 178 can travel to node 112 before reaching producer 118. As described above in relation to FIG. 1B, producer 118 can serve content or satisfy requests for content with the prefix of “/a/b/c.” Producer 118, in possession of the corresponding suffix decryption key, can decrypt the encrypted portion of name 178.1 of interest 178 (function 180), and generate a content object 184 with a name 184.1 of “/a/b/c/f” and a payload 184.2 of “<data>” (function 182). Producer 118 can replace name 186.1 in content object 186 with the original partially encrypted name (e.g., name 178.1 of “/a/b/c/Encₚₖ₁(/f)”), and transmit content object 162 to client device 116 on a reverse path (e.g., via nodes 112, 110, and 102). Note that upon receiving content object 186, node 110 can perform a lookup in its pending interest table to determine the original encrypted name 174.1 of interest 174, which allows device 116 to receive a content object that has the payload or content of responsive content object 184 (e.g., payload 184.2), and the same name (e.g., name 174.1 of “/a/b/Enc_{pk*}(/c/f”) that was sent out in original interest 174.

Thus, the communications shown in FIGS. 1A-1E illustrate how producers can publish advertisements with name prefixes and suffix encryption keys, and how routers (and, in some embodiments, client devices), can aggregate routes in their respective FIB s and transmit updated advertisements for new aggregated name prefixes and corresponding new suffix encryption keys. The system facilitates routing with minimum name disclosure by utilizing the routing protocol to update and populate the FIBs accordingly.

### Exemplary Forwarding Information Base of an Intermediate Router

FIG. 2A illustrates an exemplary forwarding information base 130 of a router, corresponding to FIB 130 of FIG. 1C, in accordance with an embodiment of the present invention. FIB 130 can include entries 130.1 and 130.2, and is an exemplary FIB for a router or client computing device that does not perform route aggregation, in accordance with an embodiment of the present invention.

FIG. 2B illustrates an exemplary forwarding information base 130.5 of a router that accounts for route aggregation, corresponding to FIG. 1A, in accordance with an embodiment of the present invention. FIB 130.5 is similar to FIB 130 of FIG. 2A, in that an entry in FIB 130.5 can include a name prefix 132, a suffix encryption key 134, and outgoing interfaces 136. Additionally, an entry in FIB 130.5 can include a suffix decryption key 135 and a list of original prefixes 137, which can be tuples of {original name prefix, original suffix encryption key, and original set of outgoing interfaces}. For example, FIB 130.5 can include an entry 190.1 with a name prefix of “/a/b/c,” a suffix encryption key of “pk1,” a suffix decryption key with a null value, outgoing interfaces “{IF1_110},” and a list of original prefixes with a null value. FIB 130.5 can also include an entry 190.2 with a name prefix of “/a/b/d,” a suffix encryption key of “pk2,” a suffix decryption key with a null value, outgoing interfaces “{IF2_110},” and a list of original prefixes with a null value.

FIG. 2C illustrates an exemplary forwarding information base 131 of a router after modification based on route aggregation, corresponding to FIB 131 of FIGS. 1C and 1D, in accordance with an embodiment of the present invention. FIB 131 can include entry 131.1, and is an exemplary FIB for a router or client computing device that performs route aggregation, in accordance with an embodiment of the present invention.

### Exemplary Forwarding Information Base of a Client Computing Device

FIG. 2D illustrates an exemplary forwarding information base 140 of a client computing device, corresponding to FIB 140 of FIG. 1C, in accordance with an embodiment of the present invention. FIB 140 can include entries 140.1 and 140.2, and is an exemplary FIB for a router or client computing device that does not perform route aggregation, in accordance with an embodiment of the present invention.

FIG. 2E illustrates an exemplary forwarding information base 141 of a client computing device (or a downstream router) after modification based on route aggregation, corresponding to FIG. 1D, in accordance with an embodiment of the present invention. An entry in FIB 141 can include a name prefix 142, a suffix encryption key 144, a suffix decryption key 145, outgoing interfaces 146, and list of original name prefixes 147. For example, entry 141.1 of FIB 141 in FIG. 2E corresponds to entry 141.1 of FIB 141 in FIG. 1D, and can additionally include a suffix decryption key and a list of original name prefixes with values that are null. Note that a client computing device or a router that is downstream from the router that sends the aggregation notification message (e.g., advertisement 124 of FIG. 1D) receives the advertisement, and determines whether to update its local FIB based on policies of the receiving device. For example, in FIG. 2E, the receiving device (e.g., client 116 of FIG. 1D) can determine to remove or replace entries 140.1 and 140.2 with new entry 141.1 for the new aggregated name prefix, based on advertisement 124.

Alternatively, as shown in FIG. 2F, the receiving device can determine not to collapse (e.g., remove or replace) entries with a new entry. FIG. 2F illustrates an alternative exemplary forwarding information base 141.5 of a client computing device (or a downstream router) after modification based on route aggregation, corresponding to FIGS. 1C and 1D, in accordance with an embodiment of the present invention. FIB 141.5 can include an entry 192.1 with a name prefix of “/a/b/c,” a suffix encryption key of “pk1,” a suffix decryption key with a null value, outgoing interfaces “{IF1_116},” and a list of original prefixes with a null value. FIB 141.5 can also include an entry 192.2 with a name prefix of “/a/b/d,” a suffix encryption key of “pk2,” a suffix decryption key with a null value, outgoing interfaces “{IF2_116},” and a list of original prefixes with a null value. FIB 141.5 can also include entry 141.1, which is the new entry for the new aggregated name prefix “/a/b,” as described above in relation to FIG. 2E.

In addition, while not shown in FIGS. 2E and 2F, note that entry 141.1 of both FIB 141 and 141.5 can include a value (i.e., not a null value) for the list of original prefixes that is equal to: “{(/a/b/c, pk1, {IF1_116}), /a/b/d, pk2, {IF2_116})}.”

### Exemplary System Including Transport Framework

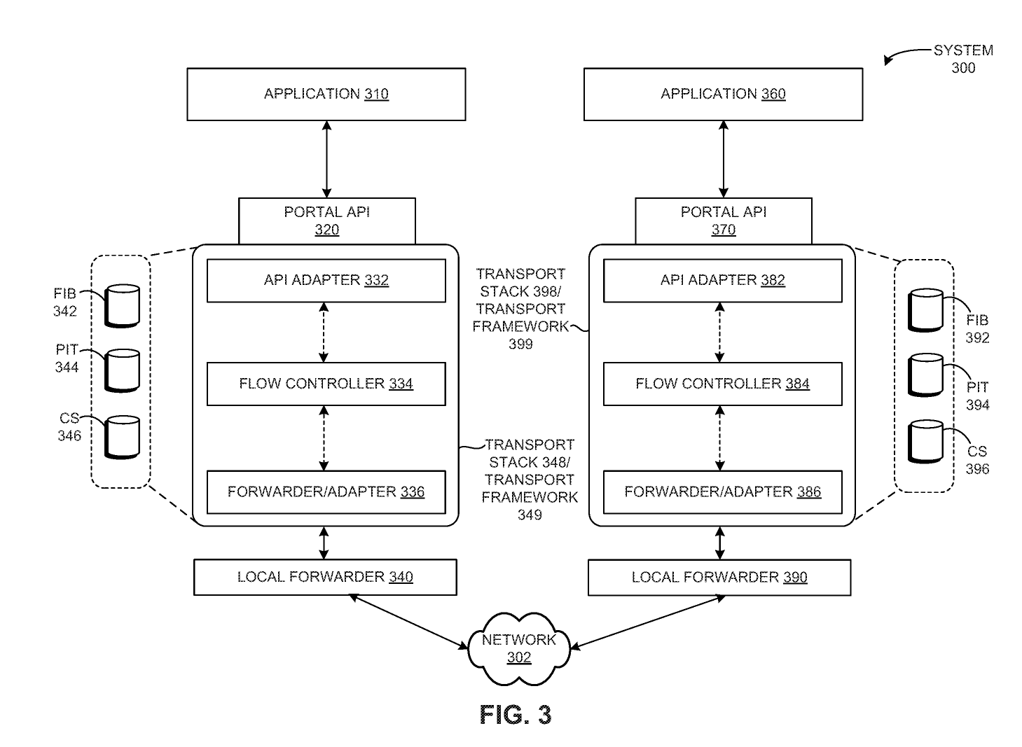

FIG. 3 illustrates an exemplary system 300 which facilitates routing with minimum name disclosure in a content centric network, in accordance with an embodiment of the present invention. System 300 can include applications 310 and 360, which can correspond to any network entity or device in a CCN, such as client computing device 116, router 110, or producer 118 of FIG. 1A. The respective devices can have internal transport stacks (e.g., associated with transport frameworks 349 and 399) that exchange network packets with each other over network 302. In addition, a respective device can include a local forwarder which can transfer packets between a stack (and individual stack components) of a transport framework and a network. For example, forwarders 340 and 390 can facilitate the transfer of packets between their respective stacks 348 and 398, and network 302, as well as between individual stack components 332-336 and 382-386, respectively. In addition, a local forwarder on a single device can service multiple applications and corresponding transport stacks. For example, an end-host with a local forwarder can use a local routing service (e.g., a local application) to publish namespace prefixes to the rest of the network using the corresponding routing protocol.

Application 310 can request a portal API instance corresponding to a portal 320, which corresponds to transport framework 349 and includes a transport stack 348. Note that while transport framework 349 is depicted as including only a single transport stack (i.e., transport stack 348), a transport framework can include multiple transport stacks. Transport stack 348 can include stack components 332, 334, and 336. An API adapter 332 can communicate between an API and a specific transport stack of transport framework 349. A flow controller 334 can shape and manage traffic, pipeline and transmit interests, and order content objects. A forwarder/adapter 336 can communicate with local forwarder 340. Other stack components (not shown) can include functionality related to security (e.g., encryption, decryption, authentication, data signing, signature verification, trust assessment, and filtering), data-processing (e.g., encoding, decoding, encapsulating, decapsulating, transcoding, compression, extraction, and decompression), and storage (e.g., data storage, data retrieval from storage, deduplication, segmentation, and versioning). Forwarder 340 can communicate with other forwarders over network 302. In addition, application 310 or transport framework 349 can access a FIB 342, a PIT 344, and a CS 346 for CCN-related purposes, as described in U.S. patent application Ser. Nos. 13/847,814 and 12/338,175, and can further populate and access FIB 342 as described herein.

Similarly, application 360 can instantiate a portal API 370 for a transport stack 398 of a transport framework 399. Transport framework 399 can include one or more transport stacks which each include multiple stack components or communication modules. In FIG. 3, transport framework 399 depicts one transport stack (e.g., transport stack 398) which includes the following stack components: an API adapter 382; a flow controller 384; and a forwarder/adapter 386. In addition, application 360 or transport framework 399 can access a FIB 392, a PIT 394, and a CS 396 for CCN-related purposes, as described in U.S. patent application Ser. Nos. 13/847,814 and 12/338,175, and can further populate and access FIB 392 as described herein.

Thus, system 300 depicts the components of devices which facilitate routing with minimum name disclosure based on a routing protocol in which producers advertise name prefixes and forwarders modify their local FIBs.

### Role of Intermediate Router

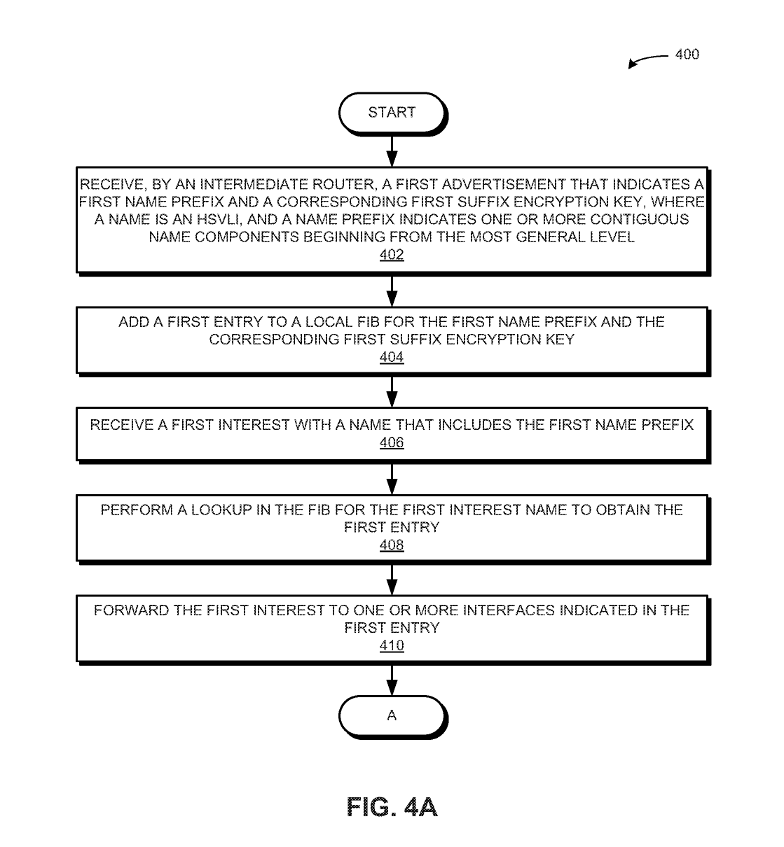

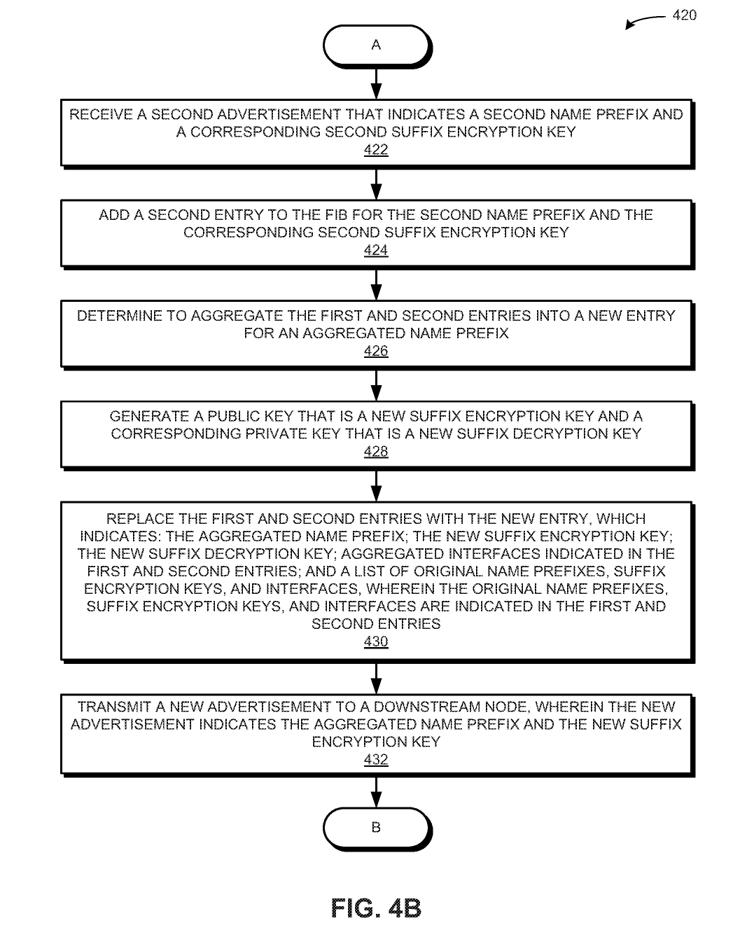

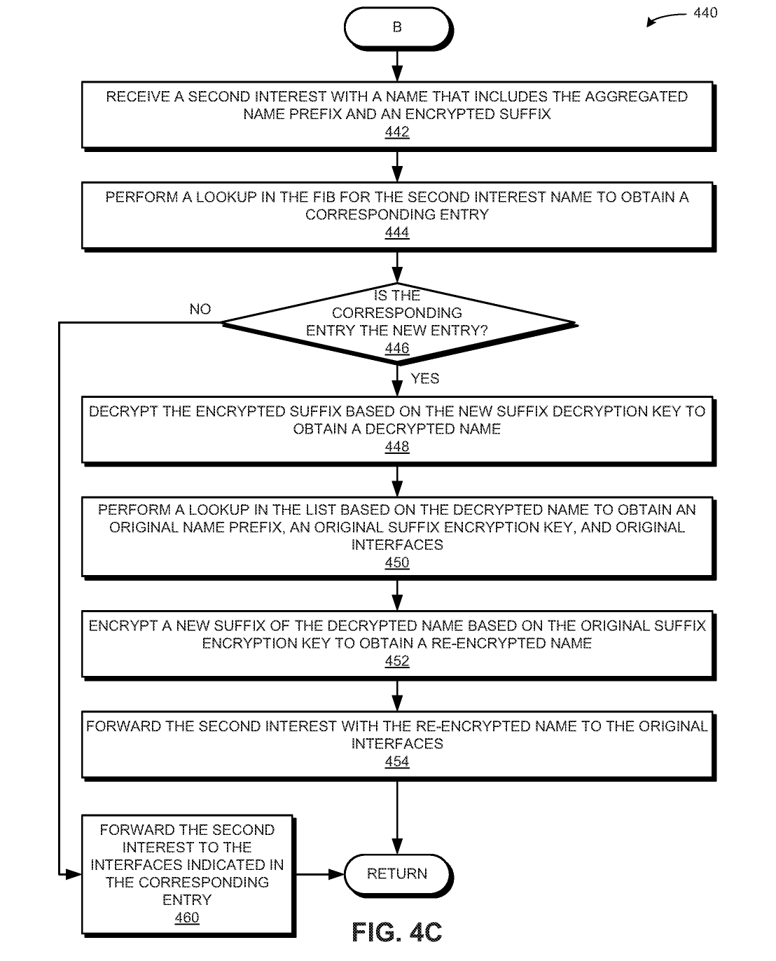

FIG. 4A presents a flow chart 400 illustrating a method by an intermediate router for facilitating routing with minimum name disclosure in a content centric network, in accordance with an embodiment of the present invention. During operation, the system receives, by an intermediate router, a first advertisement that indicates a first name prefix and a corresponding first suffix encryption key, where a name is an HSVLI, and a name prefix indicates one or more contiguous name components beginning from the most general level (operation 402). The system adds a first entry to a local FIB for the first name prefix and the corresponding first suffix encryption key (operation 404). The system receives a first interest with a name that includes the first name prefix (operation 406). The system performs a lookup in the FIB for the first interest name to obtain the first entry (operation 408). The system then forwards the interest to one or more interfaces indicated in the first entry (operation 410). The operation then continues at Label A of FIG. 4B.

FIG. 4B presents a flow chart 420 illustrating a method by an intermediate router for facilitating routing with minimum name disclosure in a content centric network, in accordance with an embodiment of the present invention. The system receives, by the intermediate router, a second advertisement that indicates a second name prefix and a corresponding second suffix encryption key (operation 422). The system adds a second entry to the FIB for the second name prefix and the corresponding second suffix encryption key (operation 424). The system determines to aggregate the first and second entries into a new entry for an aggregated name prefix (operation 426). The system generates a public key that is a new suffix encryption key, and a corresponding private key that is a new suffix decryption key (operation 428). The system replaces the first and second entries with the new entry, which indicates one or more of: the aggregated name prefix; the new suffix encryption key; the new suffix decryption key; aggregated interfaces indicated in the first and second entries; and a list of original name prefixes, suffix encryption keys, and interfaces, where the original name prefixes, suffix encryption keys, and interfaces are indicated in the first and second entries (operation 430). Subsequently, the system transmits a new advertisement to a downstream node, wherein the new advertisement indicates the aggregated name prefix and the new suffix encryption key (operation 432). The operation then continues at Label B of FIG. 4C.

FIG. 4C presents a flow chart 440 illustrating a method by an intermediate router for facilitating routing with minimum name disclosure in a content centric network, in accordance with an embodiment of the present invention. During operation, the system receive, by the intermediate router, a second interest with a name that includes the aggregated name prefix and an encrypted suffix (operation 442). The system performs a lookup in the FIB for the second interest name to obtain a corresponding entry (operation 444). The system determines whether the corresponding entry is the new entry (operation 446). If it is not, the system forwards the second interest to the outgoing interfaces indicated in the corresponding entry (operation 460).

If the corresponding entry is the new entry, the system decrypts the encrypted suffix based on the new suffix decryption key to obtain a decrypted name (operation 448). The system performs a lookup in the list of original prefixes based on the decrypted name to obtain an original name prefix, an original suffix encryption key, and original interfaces (operation 450). The system encrypts a new suffix of the decrypted name based on the original suffix encryption key to obtain a re-encrypted name (operation 452). The system then forwards the second interest with the re-encrypted name to the original interfaces (operation 454).

### Role of Client Computing Device

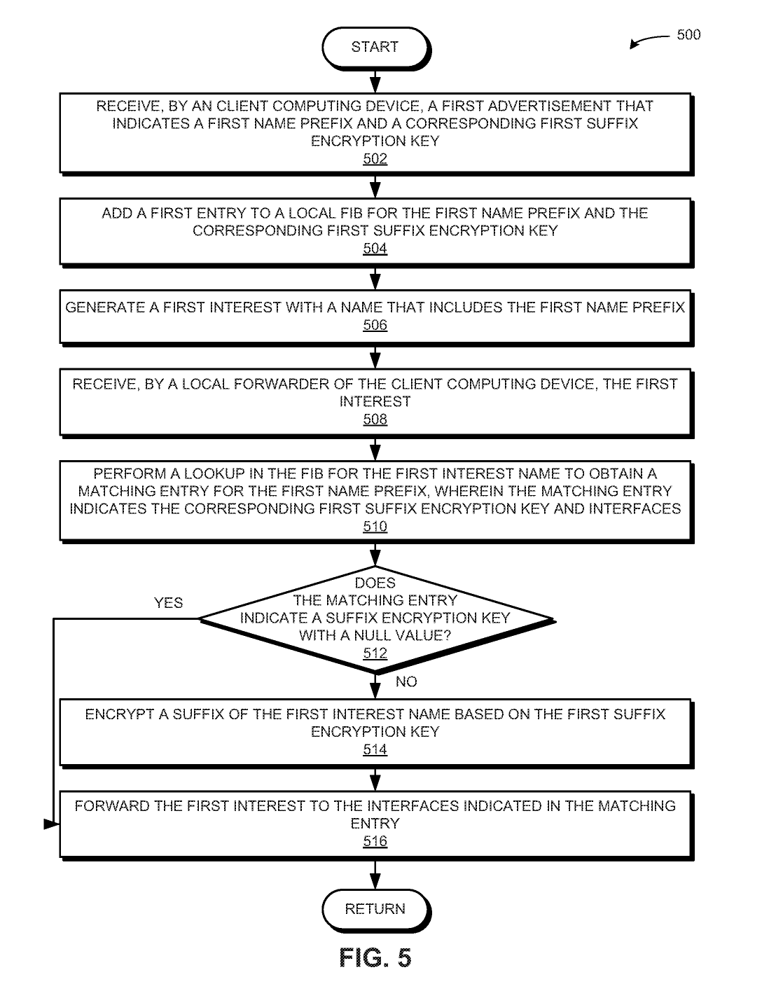

FIG. 5 presents a flow chart 500 illustrating a method by a client computing device for facilitating routing with minimum name disclosure in a content centric network, in accordance with an embodiment of the present invention. During operation, the system receives, by a client computing device, a first advertisement that indicates a first name prefix and a corresponding first suffix encryption key (operation 502). The system adds a first entry to a local FIB for the first name prefix and the corresponding first suffix encryption key (operation 504). The system generates a first interest with a name that includes the first name prefix (operation 506). The system receives, by a local forwarder of the client computing device, the first interest (operation 508). The system performs a lookup in the FIB for the first interest name to obtain a matching entry for the first name prefix, wherein the matching entry indicates the corresponding first suffix encryption key and interfaces (operation 510). The system determines whether the matching entry indicates a suffix encryption key with a null value (decision 512). If it does, the system forwards the first interest to the interfaces indicated in the matching entry (operation 516).

If the matching entry indicates a suffix encryption key that is not a null value, the system encrypts a suffix of the first interest name based on the first suffix encryption key (operation 514). The system then forwards the first interest (with the encrypted name) to the interfaces indicated in the matching entry (operation 516).

### Role of Content Producing Device

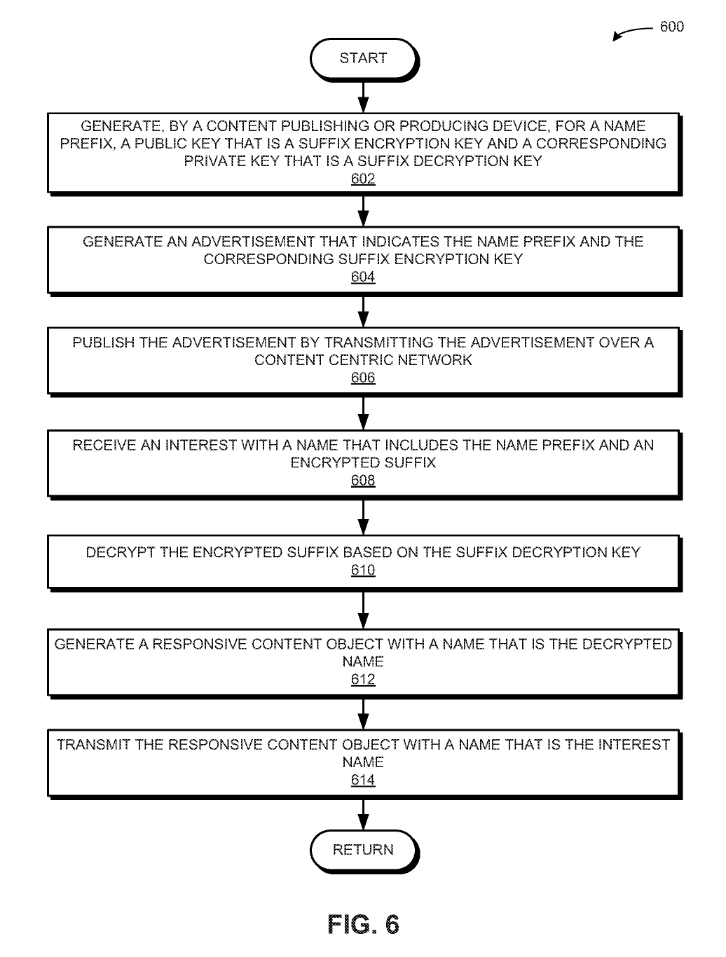

FIG. 6 presents a flow chart 600 illustrating a method by a content producing device for facilitating routing with minimum name disclosure in a content centric network, in accordance with an embodiment of the present invention. During operation, the system generates, by a content publishing or producing device, for a name prefix, a public key that is a suffix encryption key and a corresponding private key that is a suffix decryption key (operation 602). The system generates an advertisement that indicates the name prefix and the corresponding suffix encryption key (operation 604). The system publishes the advertisement by transmitting the advertisement over a content centric network (operation 606). The system receives an interest with a name that includes the name prefix and an encrypted suffix (operation 608). The system decrypts the encrypted suffix based on the suffix decryption key (operation 610). The system generates a responsive content object with a name that is the decrypted name (operation 612). The system transmits the responsive content object with a name that is the interest name (e.g., the name with the encrypted suffix) (operation 614).

### Exemplary Computer System

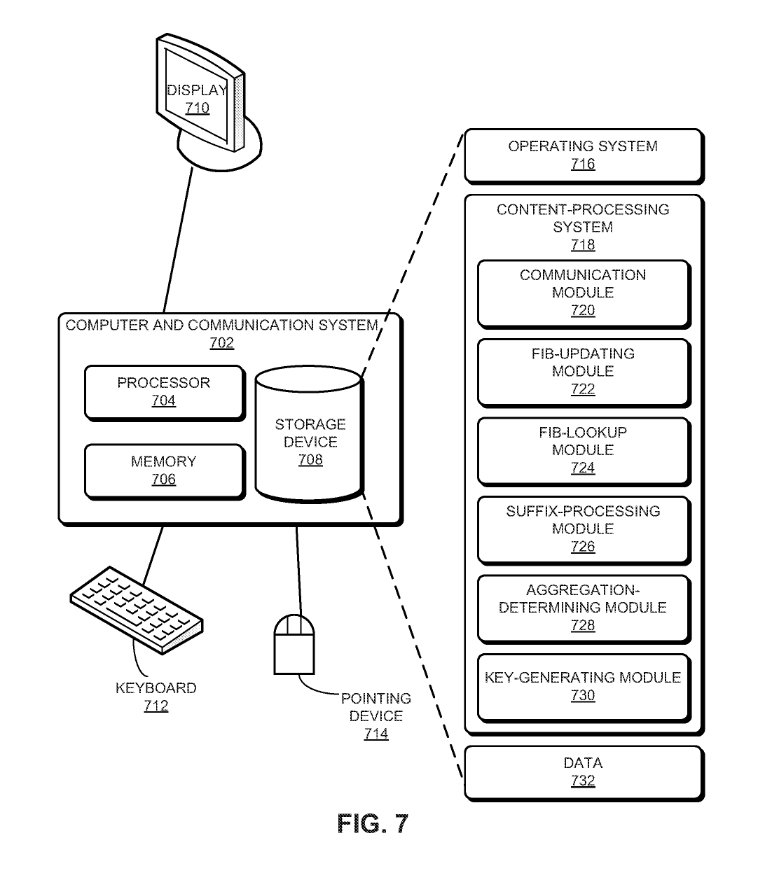

FIG. 7 illustrates an exemplary computer system 700 that facilitates routing with minimum name disclosure in a content centric network, in accordance with an embodiment of the present invention. Computer system 702 includes a processor 704, a memory 706, and a storage device 708. Memory 706 can include a volatile memory (e.g., RAM) that serves as a managed memory, and can be used to store one or more memory pools. Furthermore, computer system 702 can be coupled to a display device 710, a keyboard 712, and a pointing device 714. Storage device 708 can store an operating system 716, a content-processing system 718, and data 730.

Content-processing system 718 can include instructions, which when executed by computer system 702, can cause computer system 702 to perform methods and/or processes described in this disclosure. Specifically, content-processing system 718 may include instructions for sending and/or receiving data packets to/from other network nodes across a computer network, such as a content centric network (communication module 720). A data packet can include an advertisement, an interest packet, or a content object packet with a name which is an HSVLI that includes contiguous name components ordered from a most general level to a most specific level.

Further, content-processing system 718 can include instructions for adding a first entry to a local forwarding information base for a first name prefix and a corresponding first suffix encryption key indicated in a first advertisement (FIB-updating module 722). Content-processing system 718 can include instructions for, in response to receiving a first interest with a name that includes the first name prefix, performing a lookup in the forwarding information base for the first interest name to obtain the first entry (FIB-lookup module 724). Content-processing system 718 can also include instructions for encrypting a suffix of the first interest name based on the first suffix encryption key (suffix-processing module 726). Content-processing system 718 can include instructions for forwarding the first interest to one or more interfaces indicated in the first entry (communication module 720).

Additionally, content-processing system 718 can include instructions for adding a second entry to the forwarding information base for a second name prefix and a corresponding second suffix encryption key indicated in a second advertisement (FIB-updating module 722). Content-processing system 718 can include instructions for determining to aggregate the first and second entries into a new entry for an aggregated name prefix (aggregation-determining module 728). Content-processing system 718 can include instructions for generating a public key that is a new suffix encryption key and a corresponding private key that is a new suffix decryption key (key-generating module 730). Content-processing system 718 can also include instructions for replacing the first and second entries with the new entry (FIB-updating module 722).

Content-processing system 718 can further include instructions for receiving a second interest with a name that includes the aggregated name prefix and an encrypted suffix (communication module 720) and for performing a lookup in the forwarding information base for the second interest name to obtain a corresponding entry (FIB-lookup module 724). Content-processing system 718 can include instructions for, in response to determining that the corresponding entry is the new entry: decrypting the encrypted suffix based on the new suffix decryption key to obtain a decrypted name (FIB-lookup module 724); and performing a lookup in the list based on the decrypted name to obtain an original name prefix, an original suffix encryption key, and original interfaces (suffix-processing module 726). Content-processing system 718 can include instructions for encrypting a new suffix of the decrypted name based on the original suffix encryption key to obtain a re-encrypted name (suffix-processing module 726). Content-processing system 718 can include instructions for forwarding the second interest with the re-encrypted name to the original interfaces (communication module 720). Content-processing system 718 can additionally include instructions for, in response to determining that the corresponding entry indicates a suffix encryption key with a null value, forwarding the second interest to interfaces indicated in the corresponding entry (communication module 720).

Content-processing system 718 can include instructions for receiving an updated advertisement that indicates a third name prefix and a corresponding third suffix encryption key (communication module 720). Content-processing system 718 can include instructions for, in response to determining that an entry for the third name prefix exists in the forwarding information base, and in response to determining that the third suffix encryption key is not the same as the suffix encryption key indicated in the existing entry, replacing the suffix encryption key with the third suffix encryption key (FIB-updating module 722). Content-processing system 718 can also include instructions for, in response to determining that an entry for the third name prefix does not exist in the forwarding information base: adding a third entry to the forwarding information base for the third name prefix and the corresponding third suffix encryption key (FIB-updating module 722); and in response to determining to aggregate the first and second entries, replacing the first and second entries with the third entry (FIB-updating module 722).

Data 732 can include any data that is required as input or that is generated as output by the methods and/or processes described in this disclosure. Specifically, data 732 can store at least: an advertisement; an interest; a content object; a name; a name that is an HSVLI that includes contiguous name components ordered from a most general level to a most specific level; a routable prefix or a name prefix that indicates one or more contiguous name components beginning from the most general level; one or more encrypted name components; an interest name with a routable prefix in cleartext followed by a suffix that is encrypted; a local forwarder; stack components; a portal API; a FIB; a PIT; a CS; a FIB entry; an aggregated FIB entry; a aggregated name prefix; a suffix encryption key; a suffix decryption key; outgoing interfaces; and a list of original name prefixes, suffix encryption keys, and interfaces.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer system for facilitating routing with minimum name disclosure, the system comprising:
a processor; and
a storage device storing instructions that when executed by the processor cause the processor to perform a method, the method comprising:
adding a first entry to a local forwarding information base for a first name prefix and a corresponding first suffix encryption key indicated in a first advertisement, wherein a name is a hierarchically structured variable length identifier that includes contiguous name components ordered from a most general level to a most specific level, and wherein a name prefix indicates one or more contiguous name components beginning from the most general level;
in response to receiving a first interest with a name that includes the first name prefix, performing a lookup in the forwarding information base for the first interest name to obtain the first entry;
encrypting a suffix of the first interest name based on the first suffix encryption key, wherein the suffix begins from a name component following the first name prefix; and
forwarding the first interest to one or more interfaces indicated in the first entry, thereby facilitating routing with minimum name disclosure in a content centric network.

2. The computer system of claim 1, wherein the first advertisement is generated by a content producing device that can satisfy a request for an interest with a name that includes the first name prefix and can decrypt, based on a private key of the content producing device, a suffix encrypted based on the suffix encryption key.

3. The computer system of claim 1, wherein the method further comprises:
adding a second entry to the forwarding information base for a second name prefix and a corresponding second suffix encryption key indicated in a second advertisement; and
determining to aggregate the first and second entries into a new entry for an aggregated name prefix;
generating a public key that is a new suffix encryption key and a corresponding private key that is a new suffix decryption key;
replacing the first and second entries with the new entry that indicates one or more of:
the aggregated name prefix;
the new suffix encryption key;
the new suffix decryption key;
interfaces indicated in the first and second entries; and
a list of original name prefixes, suffix encryption keys, and interfaces, wherein the original name prefixes, suffix encryption keys, and interfaces are indicated in the first and second entries.

4. The computer system of claim 3, wherein determining to aggregate the first and second entries further comprises:
determining that one or more name components of the first name prefix are the same as one or more name components of the second name prefix.

5. The computer system of claim 3, wherein the method further comprises:
transmitting a new advertisement to a downstream node, wherein the new advertisement indicates the aggregated name prefix and the new suffix encryption key.

6. The computer system of claim 3, wherein the method further comprises:
receiving a second interest with a name that includes the aggregated name prefix and an encrypted suffix; and
performing a lookup in the forwarding information base for the second interest name to obtain a corresponding entry.

7. The computer system of claim 6, wherein the method further comprises, in response to determining that the corresponding entry is the new entry:
decrypting the encrypted suffix based on the new suffix decryption key to obtain a decrypted name;
performing a lookup in the list based on the decrypted name to obtain an original name prefix, an original suffix encryption key, and original interfaces;
encrypting a new suffix of the decrypted name based on the original suffix encryption key to obtain a re-encrypted name, wherein the new suffix begins from a name component following the original name prefix; and
forwarding the second interest with the re-encrypted name to the original interfaces.

8. The computer system of claim 6, wherein the method further comprises, in response to determining that the corresponding entry indicates a suffix encryption key with a null value:
forwarding the second interest to interfaces indicated in the corresponding entry.

9. The computer system of claim 1, wherein the method further comprises:
receiving an updated advertisement that indicates a third name prefix and a corresponding third suffix encryption key;
in response to determining that an entry for the third name prefix exists in the forwarding information base, and in response to determining that the third suffix encryption key is not the same as the suffix encryption key indicated in the existing entry, replacing the suffix encryption key with the third suffix encryption key; and
in response to determining that an entry for the third name prefix does not exist in the forwarding information base:
adding a third entry to the forwarding information base for the third name prefix and the corresponding third suffix encryption key; and
in response to determining to aggregate the first and second entries, replacing the first and second entries with the third entry.

10. The computer system of claim 1, wherein the method is performed by a local forwarder of the system, and wherein the system is a client computing device or an intermediate node or router in a content centric network.

11. A computer-implemented method for facilitating routing with minimal name disclosure, the method comprising:
adding a first entry to a local forwarding information base for a first name prefix and a corresponding first suffix encryption key indicated in a first advertisement, wherein a name is a hierarchically structured variable length identifier that includes contiguous name components ordered from a most general level to a most specific level, and wherein a name prefix indicates one or more contiguous name components beginning from the most general level;
in response to receiving a first interest with a name that includes the first name prefix, performing a lookup in the forwarding information base for the first interest name to obtain the first entry;
encrypting a suffix of the first interest name based on the first suffix encryption key, wherein the suffix begins from a name component following the first name prefix; and
forwarding the first interest to one or more interfaces indicated in the first entry, thereby facilitating routing with minimum name disclosure in a content centric network.

12. The method of claim 11, wherein the first advertisement is generated by a content producing device that can satisfy a request for an interest with a name that includes the first name prefix and can decrypt, based on a private key of the content producing device, a suffix encrypted based on the suffix encryption key.

13. The method of claim 1, further comprising:
adding a second entry to the forwarding information base for a second name prefix and a corresponding second suffix encryption key indicated in a second advertisement; and
determining to aggregate the first and second entries into a new entry for an aggregated name prefix;
generating a public key that is a new suffix encryption key and a corresponding private key that is a new suffix decryption key;
replacing the first and second entries with the new entry that indicates one or more of:
the aggregated name prefix;
the new suffix encryption key;
the new suffix decryption key;
interfaces indicated in the first and second entries; and
a list of original name prefixes, suffix encryption keys, and interfaces, wherein the original name prefixes, suffix encryption keys, and interfaces are indicated in the first and second entries.

14. The method of claim 13, wherein determining to aggregate the first and second entries further comprises:
determining that one or more name components of the first name prefix are the same as one or more name components of the second name prefix.

15. The method of claim 13, further comprising:
transmitting a new advertisement to a downstream node, wherein the new advertisement indicates the aggregated name prefix and the new suffix encryption key.

16. The method of claim 13, further comprising:
receiving a second interest with a name that includes the aggregated name prefix and an encrypted suffix; and
performing a lookup in the forwarding information base for the second interest name to obtain a corresponding entry.

17. The method of claim 16, wherein in response to determining that the corresponding entry is the new entry, the method further comprises:
decrypting the encrypted suffix based on the new suffix decryption key to obtain a decrypted name;
performing a lookup in the list based on the decrypted name to obtain an original name prefix, an original suffix encryption key, and original interfaces;
encrypting a new suffix of the decrypted name based on the original suffix encryption key to obtain a re-encrypted name, wherein the new suffix begins from a name component following the original name prefix; and
forwarding the second interest with the re-encrypted name to the original interfaces.

18. The method of claim 16, wherein in response to determining that the corresponding entry indicates a suffix encryption key with a null value, the method further comprises:
forwarding the second interest to interfaces indicated in the corresponding entry.

19. The method of claim 11, further comprising:
receiving an updated advertisement that indicates a third name prefix and a corresponding third suffix encryption key;
in response to determining that an entry for the third name prefix exists in the forwarding information base, and in response to determining that the third suffix encryption key is not the same as the suffix encryption key indicated in the existing entry, replacing the suffix encryption key with the third suffix encryption key; and
in response to determining that an entry for the third name prefix does not exist in the forwarding information base:
adding a third entry to the forwarding information base for the third name prefix and the corresponding third suffix encryption key; and
in response to determining to aggregate the first and second entries, replacing the first and second entries with the third entry.

20. The method of claim 1, wherein the method is performed by a local forwarder of the system, and wherein the system is a client computing device or an intermediate node or router in a content centric network.
